(19) United States
(12) Patent Application Publication
(10) Pub. No.: US 2011/0179766 A1
(43) Pub. Date: Jul. 28, 2011

(54) HEAT RECOVERY SYSTEM

(75) Inventor: Eduardo Fonseca, Oakdale, PA (US)

(73) Assignee: Fly Steam, LLC, Prairieville, LA (US)

(21) Appl. No.: 12/912,911

(22) Filed: Oct. 27, 2010

Related U.S. Application Data
(60) Provisional application No. 61/255,433, filed on Oct. 27, 2009.

(51) Int. Cl. B64G 1/40; F02K 99/00

(52) U.S. Cl. 60/204; 60/266

(57) ABSTRACT

An improved turbofan engine having an engine shaft and a centerbody inside of an exhaust nozzle, the turbofan engine having a fluid-filled conduit located about the centerbody and a heat recovery apparatus operatively connected to the fluid-filled conduit.

### PRIORITY CLAIM

This application claims priority to U.S. Provisional Patent Application No. 61255433, filed on Oct. 27, 2009, the entire contents of which are hereby incorporated by reference.

### BACKGROUND OF THE INVENTION

An embodiment of the present invention relates generally to a heat recovery system which utilizes wasted energy in the centerbody of an airplane.

In commercial airplanes, the engine provides power to many different systems including the pneumatic system, pressurization system, the anti-ice system, the water systems, and the reservoir pressurization of the hydraulic system. The energy needed to run these systems is drawn from the engine's high pressure compressor; therefore, the engine must work harder to achieve its selected thrust output. The dependency of the aircraft systems upon the engine creates wear on the engine by increasing rotor speed, exhaust gas temperature, and fuel flow while concurrently reducing engine performance. Additionally, the engine uses more fuel to enable it to power the above systems of the airplane. In fact, passenger twin engine aircraft consume roughly 9,000 pounds of fuel per hour during cruise depending upon in-flight conditions. The airline passenger feels the effects of this inefficiency because the increase in fuel consumption leads to increased fuel cost which is passed on to the consumer in the form of higher airline ticket costs.

As stated above, energy from the engine's high pressure compressor is used to power an aircraft's pneumatic system. An aircraft's pneumatic system supplies fresh air to the cabin. In the transfer of air to the cabin, contamination can occur if the engine has an oil or hydraulic fuel leak. This cabin-air contamination can result in flight delays and cancellations which create inconvenience for passengers and decreased revenue for airlines.

Exhaust gas is generated from the combustion of fuel within a turbofan engine. Combustion of fuel is a series of exothermic chemical reactions which generates a large amount of heat. In conventional airplanes, the exhaust gas flows into the atmosphere through an exhaust nozzle. The exhaust gas can be in the temperature range of 400 to 550 degrees Celsius. The heat generated by the combustion process is lost when the exhaust gas flows into the atmosphere; however, the flow of the exhaust gas through the exhaust nozzle transfers energy in the faun of heat energy to the exhaust nozzle itself and the centerbody located inside of the nozzle. Thus, a device and apparatus for utilizing wasted heat energy in an airplane engine is desired.

### SUMMARY OF THE INVENTION

An embodiment of the present invention can utilize heat from engine exhaust gas to convert a fluid inside of a conduit into vapor which can be transferred to a turboexpander. In one embodiment, the turboexpander can be coupled to the engine shaft to transfer the converted energy to the shaft to allow the shaft to utilize less fuel to accomplish the same power output. In another embodiment, the turboexpander can be connected to a generator which can power an air compressor.

### BRIEF DESCRIPTION OF THE DRAWINGS

FIG. 1 is a flow diagram of an embodiment of the present invention.

FIG. 2 is a flow diagram of an embodiment of the present invention.

FIG. 3 is a side view of the system diagrammed in FIG. 1.

FIG. 4 is a side view of the system diagrammed in FIG. 2.

### DETAILED DESCRIPTION OF THE DRAWINGS

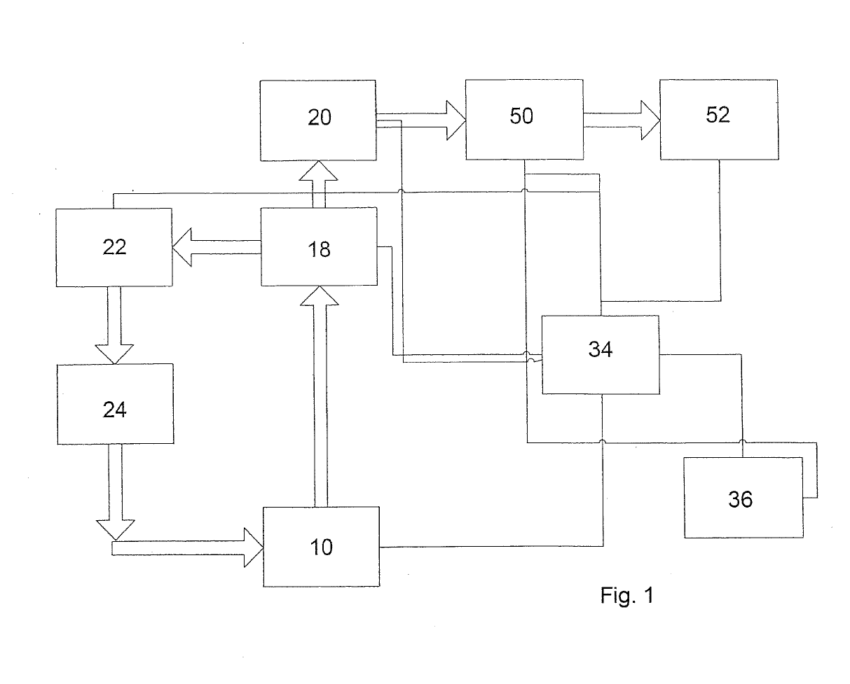

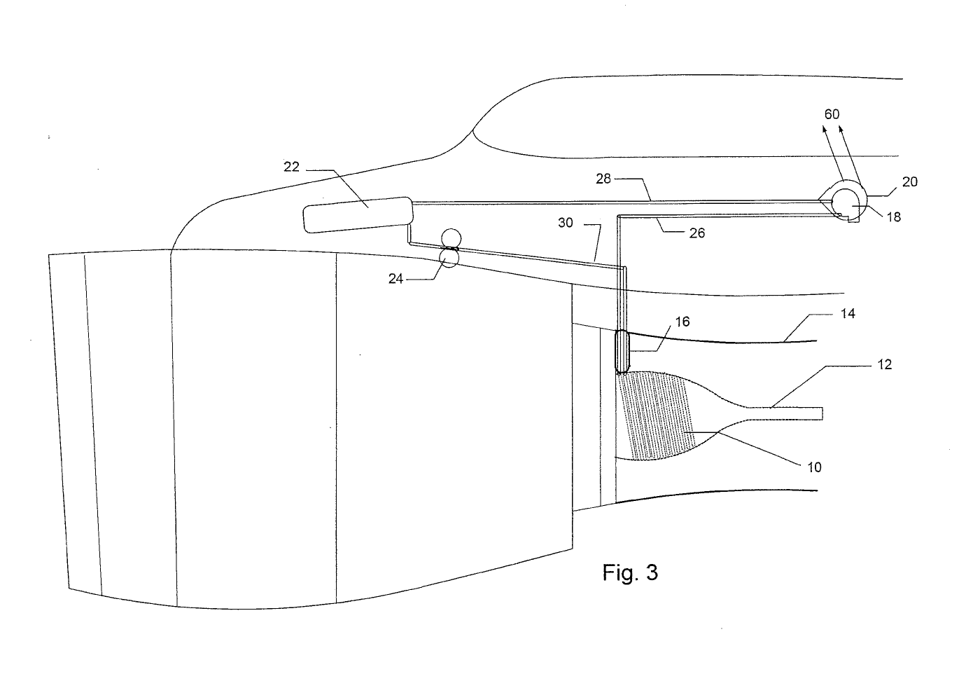

An embodiment of the present invention is an improved turbofan engine for use in an airplane. As depicted in FIG. 1, a conduit 10 can be connected to a turboexpander 18. As exhaust gas heats fluid in the conduit 10, the fluid changes to steam. As shown in FIG. 3, the fluid can pass through a steam line 26 from the conduit 10 to the turboexpander 18. As also shown in FIG. 3, the conduit 10 can be located about the centerbody 12 and adjacent or abutting the exhaust nozzle 16. The conduit 10 can be in any shape which allows the fluid to flow to the turboexpander 18.

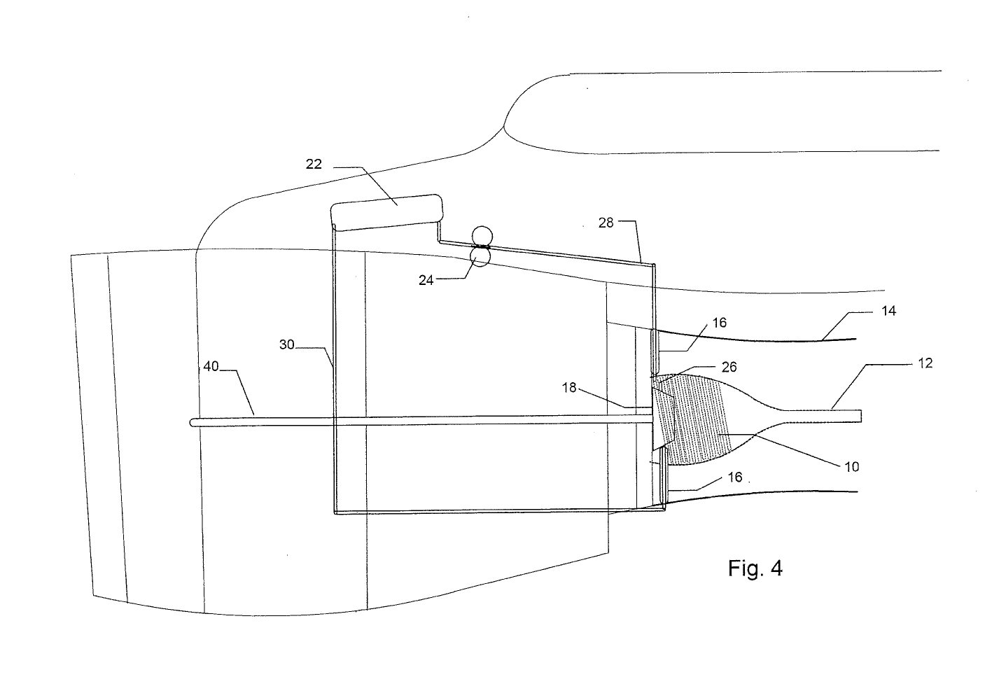

Returning to FIG. 1, the turboexpander 18 can be connected to a generator 20 that can power an air blower 50. The air blower 50 can deliver fresh air to an airplane's pneumatic system 52. The vapor from the turboexpander 18 can travel through a vapor return 28 to a condenser 22. As shown in FIG. 3, the condenser 22 can return the fluid to a fluid pump 24 and through a fluid return 30 to the evaporator 10. A fairing 16 can be utilized to reduce exhaust gas drag. As shown in FIG. 4, more than one fairing 16 can used as needed to reduce exhaust gas drag.

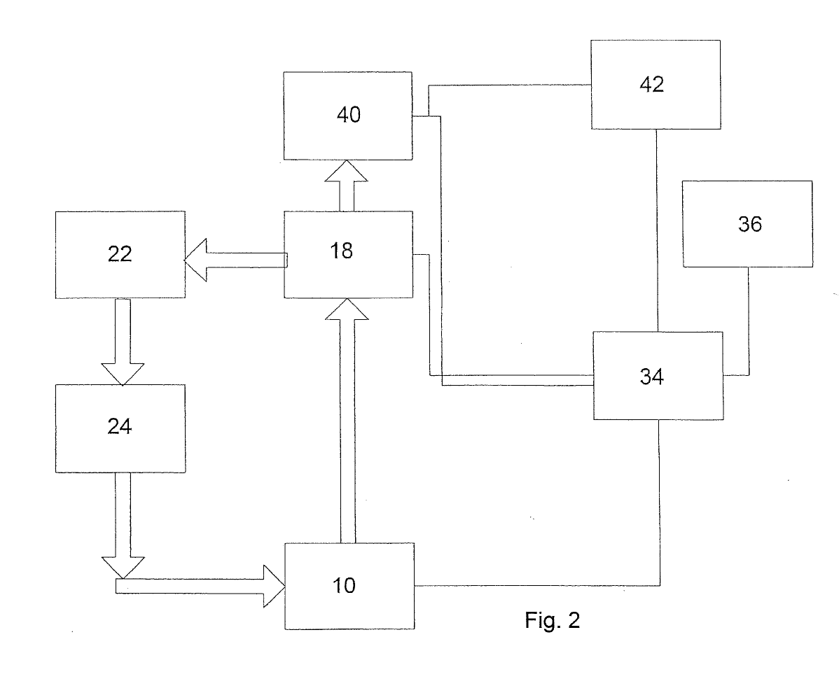

In an alternate embodiment, depicted in FIG. 2, the turboexpander 18 can be connected to the engine shaft 40. The engine shaft 40 then delivers the energy from the turboexpander 18 to the engine electrical control unit 42 for use in powering the engine systems.

The conduit 10 can be in the form of a coiled tube. The tube can be composed of aluminum, copper, stainless steel, carbon steel, alloy steel or any other suitable material. Additionally, the coiled tube can have a circular cross section or a polygonal cross section. In an embodiment, the conduit 10 can be in the faun of a coiled tube with a rectangular cross section for increased heat transfer without significantly lowering the liquid convection coefficient of the fluid. The conduit 10 can be placed approximately 40 inches downstream from the throat of the exhaust nozzle 14.

In another embodiment of the present invention, the conduit 10, the centerbody 12, or both can be fitted with fins, abrasions or any other type of contouring devices to create more turbulence about the conduit 10.

The embodiments shown in the drawings and described above are exemplary of numerous embodiments that may be made within the scope of the appended claims. It is contemplated that numerous other configurations may be used, and the material of each component may be selected from numerous materials other than those specifically disclosed. In short, it is the applicant's intention that the scope of the patent issuing herefrom will be limited by the scope of the appended claims.

1. A turbofan engine having an engine shaft and a centerbody inside of an exhaust nozzle, the turbofan engine comprising:
a. a conduit, the conduit located about the centerbody;
b. a heat recovery apparatus, wherein the heat recovery apparatus is operatively connected to the conduit.

2. The turbofan engine of claim 1 wherein the conduit adjoins the wall of the centerbody.

3. The turbofan engine of claim 1 wherein the conduit is a coiled tube.

4. The turbofan engine of claim 1, wherein the tube has a circular cross section.

5. The turbofan engine of claim 1, wherein the tube has a polygonal cross section.

6. The turbofan engine of claim 1, wherein the centerbody is contoured.

7. The turbofan engine of claim 1, wherein the heat recovery apparatus is operatively connected to a regulator.

8. A heat recovery system for an airplane turbofan engine having an engine shaft and a centerbody inside an exhaust nozzle, the system comprising:
a. a conduit, the conduit located about the centerbody;
b. a fluid within the conduit, wherein the conduit is positioned to utilize heat energy to convert the fluid into vapor;
c. a turboexpander, wherein the turboexpander is driven by the vapor flowing from the conduit through a passage;
d. a condenser connected to the turboexpander by a vapor return;
e. a pump, wherein the pump directs fluid from the condenser to the conduit.

9. The system of claim 8, wherein the conduit adjoins the wall of the centerbody.

10. The system of claim 8 wherein the conduit is a coiled tube.

11. The system of claim 8, wherein the tube has a circular cross section.

12. The system of claim 8, wherein the tube has a polygonal cross section.

13. The system of claim 8, wherein the fluid is water.

14. The system of claim 8, wherein the fluid is refrigerant.

15. The system of claim 8, wherein the center section is contoured.

16. The system of claim 8, wherein the turboexpander is operatively connected to a generator, wherein the generator powers a compressor.

17. The system of claim 8, wherein the turboexpander is operatively connected to the engine shaft.

18. The system of claim 8, wherein the heat energy is generated by exhaust gas.

19. A method for conducting airflow in an airplane having a pneumatic system and a turbofan engine, the engine having a centerbody inside of an exhaust nozzle, the method comprising:
a. installing a fluid-filled conduit in the centerbody of the airplane;
b. heating the fluid to produce vapor;
c. directing the vapor to drive a turboexpander wherein the turboexpander is operatively connected to a generator; and
d. utilizing the electricity produced by the generator to power a compressor, whereby the compressor generates air flow to the pneumatic system.
